(19) United States
(12) Patent Application Publication
(10) Pub. No.: US 2002/0085152 A1
(43) Pub. Date: Jul. 4, 2002

(54) Continuous domain inverse twisted-nematic liquid crystal display and method for manufacturing the same

(76) Inventors: Li-Sen Chuang, Penghu Hsien (TW); Ching-Yih Chen, Miaoli Hsien (TW)

Correspondence Address: BIRCH STEWART KOLASCH & BIRCH, PO BOX 747, FALLS CHURCH, VA, 22040-0747, US

(21) Appl. No.: 09/852,306

(22) Filed: May 10, 2001

(30) Foreign Application Priority Data
Dec. 29, 2000 (TW) 89128291

(51) Int. Cl. G02F 1/1337

(52) U.S. Cl. 349/123

(57) ABSTRACT

A continuous domain inverse twisted-nematic liquid crystal display and a method for manufacturing the same are provided, which can provide a wide viewing angle and excellent transmittance. The liquid crystal display includes: a first substrate; a first electrode formed on an inner side of the first substrate with a non-rectangular pattern, in which a symmetric protrusion is formed on the first electrode and an alignment layer is coated thereon; a second substrate having an inner side thereof against the inner side of the first substrate; a second electrode formed on the inner side of the second substrate, in which a protrusion is formed at the center of the second electrode and an alignment layer is coated thereon; a liquid crystal layer having liquid crystal molecules having a negative dielectric anisotropy formed between the first substrate and the second substrate and added with chiral agent; a first polarizer placed on an outer side of the first substrate; and a second polarizer placed on an outer side of the second substrate. While applying an external electric field, the liquid crystal molecules at the same layer are continuously aligned in a radiating manner due to the protrusion and the electric field distribution of the ITO electrode. The alignment of the liquid crystal molecules along the z-axis is a twisted alignment with a twist angle of 90°. Thus, no matter what the angle is between the liquid crystal molecule and the polarizer, a high transmittance can be obtained.

### BACKGROUND OF THE INVENTION

1. Field of the Invention

The present invention relates to a liquid crystal display device, and more particularly to a continuous domain inverse twisted-nematic liquid crystal display and a method for manufacturing the same.

2. Description of the Related Art

Wide viewing angle techniques applied to liquid crystal display (LCD) devices include in-plane switching (IPS) mode, vertical aligned (VA) mode and twisted nematic (TN) mode with a compensation film, etc. Currently, the MVA (multi-domain vertical aligned) mode provided by Fujitsu Co. and the PVA (pattern vertical aligned) mode by Samsung Co. have occupied most of the market. These two examples of prior art provide the effect of wide viewing angle by forming multi-domain in each pixel of liquid crystal display. However, a dark line or domain boundary appears between two neighboring domains. Such a disclination line degrades the display quality and the response time of the LCD devices. As to IPS mode, the transmittance is unsatisfactory due to the existence of the metal electrode. As to the TN type LCD with tilted discotic-LC compensator, there is still a gray scale inversion that occurs at the lower viewing angle.

### SUMMARY OF THE INVENTION

Accordingly, in order to overcome the drawbacks of the prior art, an object of the present invention is to provide a continuous domain inverse TN LCD and a method for manufacturing the same, which can provide a wide viewing angle and an excellent transmittance.

In this invention, the liquid crystal molecules can be symmetrically aligned and act as TN liquid crystal after applying an electric field.

To achieve the above object, inverse TN liquid crystal is used in this invention. Moreover, chiral agent is added into the liquid crystal in this invention, so that the liquid crystal molecules are vertically aligned when there is no applied electric field, and the alignment of the liquid crystal molecules is the same as TN liquid crystal while an external electric field is applied. Furthermore, in order to form a circular symmetric continuous domain for the liquid crystal molecules in a pixel, this invention provides a pixel electrode with a non-rectangular pattern such as ellipse or circle and forms a symmetric protrusion in the pixel electrode to enhance the pretilt for the liquid crystal molecules.

The LCD device of this invention has a wide viewing angle since the alignment of the liquid crystal molecules is circular symmetric. Moreover, the transmittance of the LCD device is high since the liquid crystal molecules are aligned as TN liquid crystal when an external electric field is applied to the liquid crystal.

### BRIEF DESCRIPTION OF THE DRAWINGS

The present invention can be more fully understood by reading the subsequent detailed description in conjunction with the examples and references made to the accompanying drawings, wherein:

FIG. 1A is a diagram illustrating the continuous domain inverse TN LCD device according to one embodiment of this invention;

FIG. 1B is a diagram illustrating the continuous domain inverse TN LCD device according to another embodiment of this invention;

FIG. 1C is a diagram illustrating the continuous domain inverse TN LCD device according to still another embodiment of this invention;

FIG. 1D is a diagram illustrating the continuous domain inverse TN LCD device according to a further embodiment of this invention;

FIG. 2A is a top view of the lower plate of the LCD device as shown in FIG. 1A;

FIG. 2B is a top view of the upper plate of the LCD device as shown in FIG. 1B;

FIG. 2C is a top view of the lower plate of the LCD device as shown in FIG. 1C;

FIGS. 2D and 2E are top views respectively illustrating the upper plate and the lower plate of the LCD device as shown in FIG. 1D;

FIG. 3 is a front view of a transparent electrode used in the continuous domain inverse TN LCD device of this invention;

FIG. 4 is a diagram illustrating the alignment of the liquid crystal molecules in the continuous domain inverse TN LCD device of this invention while an electric field is applied thereto; and

FIG. 5 is a diagram illustrating the alignment of the liquid crystal molecules along the z-axis in the continuous domain inverse TN LCD device of this invention while an electric field is applied thereto.

### DETAILED DESCRIPTION OF THE PREFERRED EMBODIMENT

The embodiments of the continuous domain inverse TN LCD device and the manufacturing method are described below with reference to the drawings.

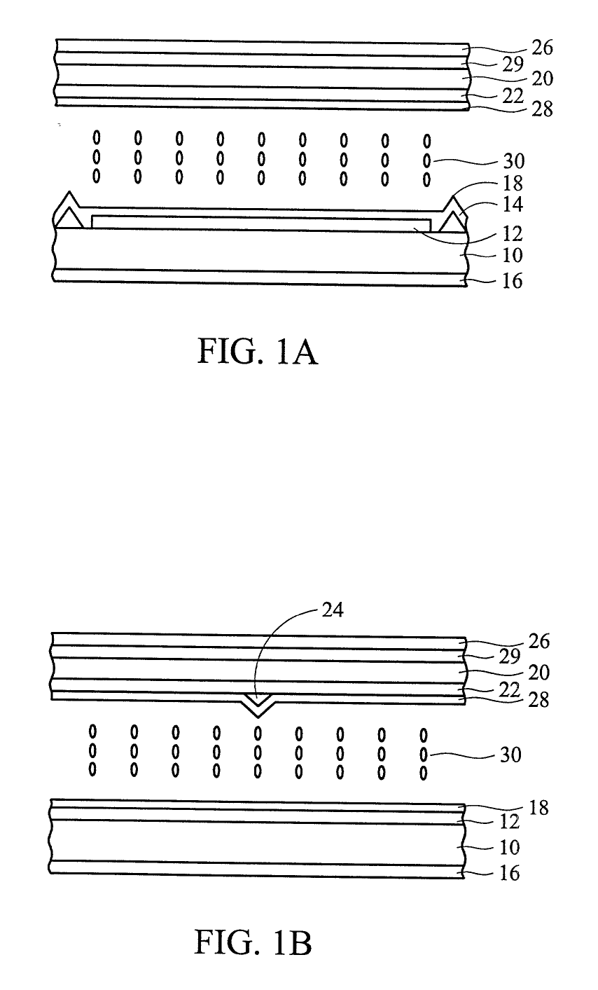

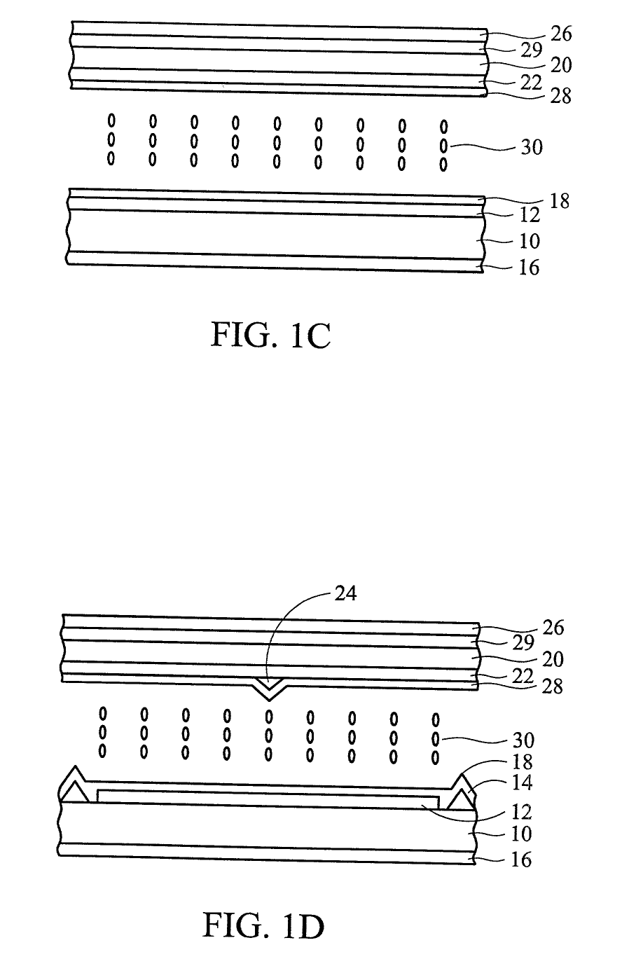

Referring to FIG. 1A, according to the first embodiment of this invention, the continuous domain inverse TN LCD device includes: a first substrate 10; a first electrode 12 formed on the inner side of the first substrate 10, in which a symmetric protrusion 14 is formed on the first electrode 12; a first alignment layer 18 formed on the first electrode 12 and the symmetric protrusion 14; a second substrate 20 having the inner side thereof against the inner side of the first substrate 10; a second electrode 22 formed on the inner side of the second substrate 20; a second alignment layer 28 formed on the second electrode 22; a liquid crystal layer having liquid crystal molecules having a negative dielectric anisotropy 30, which is added with chiral agent and formed between the first substrate 10 and the second substrate 20; a first polarizer 16 disposed on the outer side of the first substrate 10; and a second polarizer 26 disposed on the outer side of the second substrate 20.

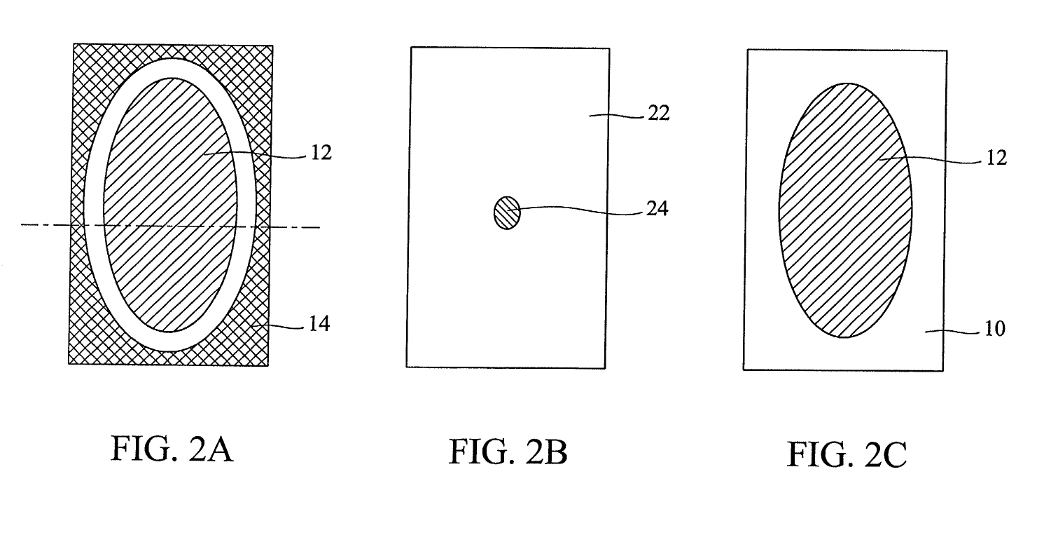

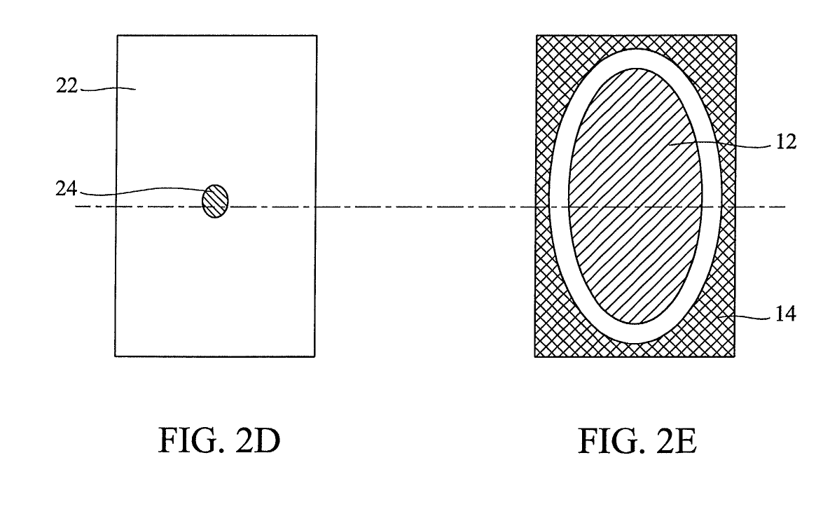

Referring to FIG. 2A, which illustrates the top view of the lower plate of the LCD device shown in FIG. 1A.

The manufacturing method of the LCD device of this embodiment includes the steps of: (i) forming a first electrode 12 on the inner side of the first substrate 10 and forming a symmetric protrusion 14 on the first electrode; (ii) coating a first alignment layer 18 on the first electrode 12 and the symmetric protrusion 14; (iii) forming a second electrode 22 on the inner side of the second substrate 20; (iv) coating a second alignment layer 28 on the second electrode 22; (v) adhering the first substrate 10 to the second substrate 20 with the inner side of the first substrate 10 against the inner side of the second substrate 20; (vi) adding the chiral agent to the liquid crystal layer 30 having liquid crystal molecules having negative dielectric anisotropy, and forming the liquid crystal layer 30 between the first substrate 10 and the second substrate 20; (vii) placing a first polarizer 16 and a second polarizer 26 on the outer sides of the first substrate 10 and the second substrate 20, respectively; and (viii) placing an optical compensating film 29 between the second polarizer 26 and the second substrate 20.

Referring to FIG. 1B, according to the second embodiment of this invention, the continuous domain inverse TN LCD device includes: a first substrate 10; a first electrode 12 formed on the inner side of the first substrate 10; a first alignment layer 18 formed on the first electrode 12; a second substrate 20 having the inner side thereof against the inner side of the first substrate 10; a second electrode 22 formed on the inner side of the second substrate 20, in which a protrusion 24 is formed at the center of the second electrode 22; a second alignment layer 28 formed on the second electrode 22 and the protrusion 24; a liquid crystal layer 30 having liquid crystal molecules having a negative dielectric anisotropy, which is added with chiral agent and formed between the first substrate 10 and the second substrate 20; a first polarizer 16 placed on the outer side of the first substrate 10; a second polarizer 26 placed on the outer side of the second substrate 20; and an optical compensating film 29 placed between the second polarizer 26 and the second substrate 20.

Referring to FIG. 2B, which illustrates the top view of the upper plate of the LCD device shown in FIG. 1B.

The manufacturing method of the LCD device of this embodiment includes the steps of: (i) forming a first electrode 12 on the inner side of the first substrate 10; (ii) coating a first alignment layer 18 on the first electrode 12; (iii) forming a second electrode 22 on the second substrate 20 and forming a protrusion 24 at the center of the second electrode 22; (iv) coating a second alignment layer 28 on the second electrode 22 and the protrusion 24; (v) adhering the first substrate 10 to the second substrate 20 with the inner side of the first substrate 10 against the inner side of the second substrate 20; (vi) adding the chiral agent to the liquid crystal layer 30 having liquid crystal molecules having a negative dielectric anisotropy, and forming the liquid crystal 30 between the first substrate 10 and the second substrate 20; (vii) placing a first polarizer 16 and a second polarizer 26 to the outer sides of the first substrate 10 and the second substrate 20, respectively; and (viii) placing an optical compensating film between the second polarizer 26 and the second substrate 20.

Referring to FIG. 1C, according to the third embodiment of this invention, the continuous domain inverse TN LCD device includes: a first substrate 10; a first electrode 12 formed on the inner side of the first substrate 10, in which the first electrode 12 is formed with a non-rectangular pattern; a first alignment layer 18 formed on the first electrode 12; a second substrate 20 having the inner side thereof against the inner side of the first substrate 10; a second electrode 22 formed on the inner side of the second substrate 20; a second alignment layer 28 formed on the second electrode 22; a liquid crystal layer 30 having liquid crystal molecules having a negative dielectric anisotropy, which is added with chiral agent and formed between the first substrate 10 and the second substrate 20; a first polarizer 16 placed on the outer side of the first substrate 10; and a second polarizer 26 placed on the outer side of the second substrate 20; and an optical compensating film 29 placed between the second polarizer 26 and the second substrate 20.

Referring to FIG. 2C, which illustrates the top view of the lower plate of the LCD device shown in FIG. 1C.

The manufacturing method of the LCD device of this embodiment includes the steps of: (i) forming a first electrode 12 on the inner side of the first substrate 10, in which the first electrode 12 is formed with a non-rectangular pattern; (ii) coating a first alignment layer 18 on the first electrode 12; (iii) forming a second electrode 22 on the second substrate 20; (iv) coating a second alignment layer 28 on the second electrode 22; (v) adhering the first substrate 10 to the second substrate 20 with the inner side of the first substrate 10 against the inner side of the second substrate 20; (vi) adding the chiral agent to the liquid crystal layer 30 having liquid crystal molecules having a negative dielectric anisotropy, and forming the liquid crystal layer 30 between the first substrate 10 and the second substrate 20; (vii) placing a first polarizer 16 and a second polarizer 26 to the outer sides of the first substrate 10 and the second substrate 20, respectively; and (viii) placing an optical compensating film 29 between the second polarizer 26 and the second substrate 20.

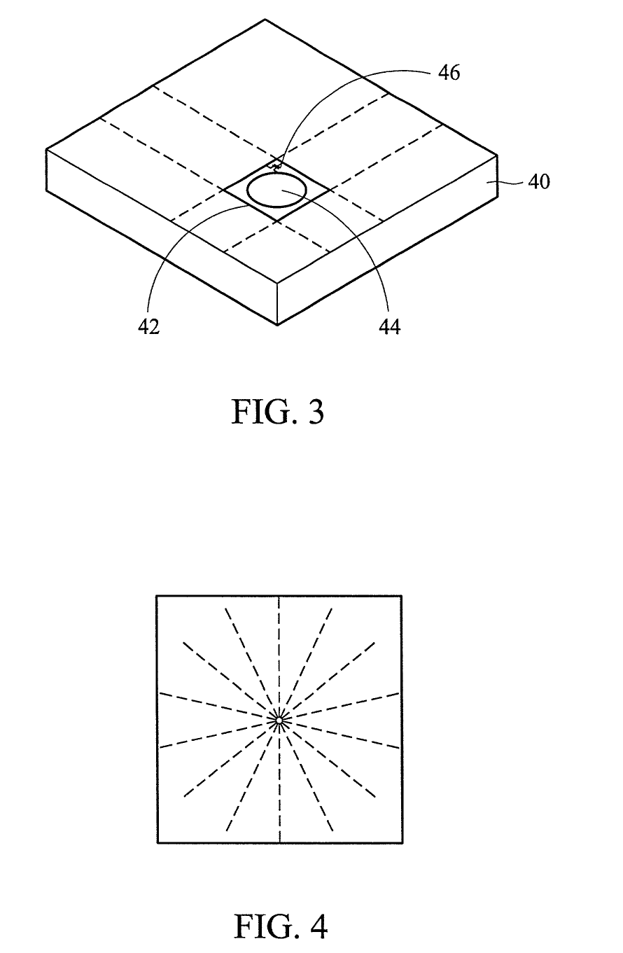

Referring to FIG. 3, in step (i) of the previous embodiment, the ITO electrode 44 is formed with a non-rectangular pattern in a pixel 42 on the substrate 40. For example, the ITO electrode can be circular if the pixel is square or the ITO electrode can be elliptic if the pixel is rectangular. Furthermore, the voltage of the ITO electrode is controlled by an active component 46 such as a thin-film transistor.

The fourth embodiment of this invention is similar to the first embodiment except that a protrusion is formed in the center of the second electrode as shown in FIG. 1D to provide a pretilt direction for the liquid crystal molecules. Referring to FIGS. 2D and 2E, which respectively illustrate the top view of the upper plate and the lower plate of the LCD device shown in FIG. 1D.

The other embodiments are similar to the first, the second and the fourth embodiments except that the first electrode in the other embodiments can be formed with a non-rectangular pattern as described in the third embodiment.

In the manufacturing method described above, no rubbing step is performed for the alignment of the liquid crystal molecules. The liquid crystal molecules are aligned with a pretilt direction near the symmetrical protrusion. The pretilt angle of the liquid crystal molecules is about 90°.

In the above embodiments, the pitch of the chiral agent is less than eight times of the cell gap and is larger than two times of the cell gap. Moreover, both the first electrode and the second electrode are ITO electrodes.

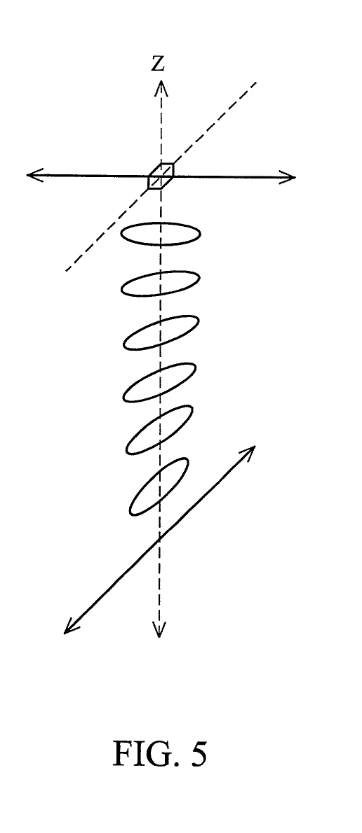

As shown in FIG. 4, while applying an external electric field, the liquid crystal molecules at the same layer are continuously radiately aligned due to the protrusion and the electric field distribution of the ITO electrode. The alignment of the liquid crystal molecules along the z-axis is a twisted alignment with a twist angle of 90° as shown in FIG. 5. Thus, no matter what the angle between the liquid crystal molecule and the polarizer is, a high transmittance can be obtained. The only opaque portion is a point at the center of the whole pixel, which is the singular point of the alignment of the liquid crystal molecules. Therefore the LCD of this invention is provided with a transmittance as high as a TN-mode LCD. Furthermore, as shown in FIG. 4, the alignment of the liquid crystal molecules is circularly symmetric, thus the LCD of this invention has a wide viewing angle.

The LCD devices of the above embodiments are used to describe the features of this invention. Therefore only fundamental components are included. In fact, this invention can be applied to various structures of LCD devices if the liquid crystal material used is a liquid crystal having liquid crystal molecules having a negative dielectric anisotropy, which is added with chiral agent.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A continuous domain inverse twisted nematic liquid crystal display device including:
a first substrate;
a first electrode formed on an inner side of the first substrate with a non-rectangular pattern;
a first alignment layer formed on the first electrode;
a second substrate having an inner side thereof against the inner side of the first substrate;
a second electrode formed on the inner side of the second substrate;
a second alignment layer formed on the second electrode;
a liquid crystal layer having liquid crystal molecules having a negative dielectric anisotropy formed between the first substrate and the second substrate and added with chiral agent in which the chiral agent has a chiral pitch p, 2d<p<8d where d is the cell gap;
a first polarizer placed on an outer side of the first substrate;
a second polarizer placed on an outer side of the second substrate; and
an optical compensating film placed between the second polarizer and the second substrate.

2. A continuous domain inverse twisted nematic liquid crystal display device including:
a first substrate;
a first electrode formed on an inner side of the first substrate, in which a symmetric protrusion is formed on the first electrode;
a first alignment layer formed on the first electrode and the symmetric protrusion;
a second substrate having an inner side thereof against the inner side of the first substrate;
a second electrode formed on the inner side of the second substrate;
a second alignment layer formed on the second electrode;
a liquid crystal layer having liquid crystal molecules having a negative dielectric anisotropy formed between the first substrate and the second substrate and added with chiral agent in which the chiral agent has a chiral pitch p, 2d<p<8d where d is the cell gap;
a first polarizer placed on an outer side of the first substrate;
a second polarizer placed on an outer side of the second substrate; and
an optical compensating film placed between the second polarizer and the second substrate.

3. A continuous domain inverse twisted nematic liquid crystal display device including:
a first substrate;
a first electrode formed on an inner side of the first substrate;
a first alignment layer formed on the first electrode;
a second substrate having an inner side thereof against the inner side of the first substrate;
a second electrode formed on the inner side of the second substrate, in which a protrusion is formed at the center of the second electrode;
a second alignment layer formed on the second electrode and the protrusion;
a liquid crystal layer having liquid crystal molecules having a negative dielectric anisotropy formed between the first substrate and the second substrate and added with chiral agent in which the chiral agent has a chiral pitch p, 2d<p<8d where d is the cell gap;
a first polarizer placed on an outer side of the first substrate;
a second polarizer placed on an outer side of the second substrate; and
an optical compensating film placed between the second polarizer and the second substrate.

4. The liquid crystal display device as claimed in claim 1 wherein a symmetric protrusion is formed on the first electrode.

5. The liquid crystal display device as claimed in claim 1 wherein a protrusion is formed at the center of the second electrode.

6. The liquid crystal display device as claimed in claim 1 wherein a symmetric protrusion is formed on the first electrode and a protrusion is formed at the center of the second electrode.

7. The liquid crystal display device as claimed in claim 2 wherein a protrusion is formed at the center of the second electrode.

8. The liquid crystal display device as claimed in claim 1 wherein the voltage of the first electrode is controlled by an active component.

9. The liquid crystal display device as claimed in claim 2 wherein the voltage of the first electrode is controlled by an active component.

10. The liquid crystal display device as claimed in claim 3 wherein the voltage of the first electrode is controlled by an active component.

11. The liquid crystal display device as claimed in claim 8 wherein the active component is a thin film transistor.

12. The liquid crystal display device as claimed in claim 9 wherein the active component is a thin film transistor.

13. The liquid crystal display device as claimed in claim 10 wherein the active component is a thin film transistor.

14. A method for manufacturing a continuous domain inverse twisted nematic liquid crystal display device including the steps of:
(i) forming a first electrode on an inner side of a first substrate and forming a symmetric protrusion on the first electrode;
(ii) coating a first alignment layer on the first electrode and the symmetric protrusion;
(iii) forming a second electrode on a second substrate;
(iv) coating a second alignment layer on the second electrode;
(v) adhering the first substrate to the second substrate with the inner side of the first substrate against the inner side of the second substrate;
(vi) adding a chiral agent to a liquid crystal layer having liquid crystal molecules having a negative dielectric anisotropy, and forming the liquid crystal layer between the first substrate and the second substrate;
(vii) placing a first polarizer and a second polarizer to outer sides of the first substrate and the second substrate, respectively; and
(viii) placing an optical compensating film between the second polarizer and the substrate.

15. A method for manufacturing a continuous domain inverse twisted nematic liquid crystal display device including the steps of:
(i) forming a first electrode on an inner side of a first substrate with a non-rectangular pattern;
(ii) coating a first alignment layer on the first electrode;
(iii) forming a second electrode on a second substrate;
(iv) coating a second alignment layer on the second electrode;
(v) adhering the first substrate to the second substrate with the inner side of the first substrate against the inner side of the second substrate;
(vi) adding a chiral agent to a liquid crystal layer having liquid crystal molecules having a negative dielectric anisotropy, and forming the liquid crystal layer between the first substrate and the second substrate;
(vii) placing a first polarizer and a second polarizer to outer sides of the first substrate and the second substrate, respectively; and
(viii) placing an optical compensating film between the second polarizer and the second substrate.

16. A method for manufacturing a continuous domain inverse twisted nematic liquid crystal display device including the steps of:
(i) forming a first electrode on an inner side of a first substrate;
(ii) coating a first alignment layer on the first electrode;
(iii) forming a second electrode on a second substrate and forming a protrusion at the center of the second electrode;
(iv) coating a second alignment layer on the second electrode and the protrusion;
(v) adhering the first substrate to the second substrate with the inner side of the first substrate against the inner side of the second substrate;
(vi) adding a chiral agent to a liquid crystal layer having liquid crystal molecules having a negative dielectric anisotropy, and forming the liquid crystal layer between the first substrate and the second substrate;
(vii) placing a first polarizer and a second polarizer to outer sides of the first substrate and the second substrate, respectively; and
(viii) placing an optical compensating film between the second polarizer and the second substrate.

17. A method as claimed in claim 14 further including the step of forming the first electrode with a non-rectangular pattern in step (i).

18. A method as claimed in claim 14 further including the steps of forming the first electrode with a non-rectangular pattern in step (i) and forming a protrusion at the center of the second electrode in step (ii).

19. A method as claimed in claim 14 further including the step of forming a protrusion at the center of the second electrode in step (ii).

20. A method as claimed in claim 15 further including the step of forming a protrusion at the center of the second electrode in step (ii).

21. A method as claimed in claim 15 wherein the alignment of the liquid crystal molecules is circular symmetric while applying an external electric field to the liquid crystal layer.
